(19) United States
(12) Patent Application Publication
(10) Pub. No.: US 2011/0069298 A1
(43) Pub. Date: Mar. 24, 2011

(54) SUPPORT OR TABLE FOR LITHOGRAPHIC APPARATUS, METHOD OF MANUFACTURING SUCH SUPPORT OR TABLE AND LITHOGRAPHIC APPARATUS COMPRISING SUCH SUPPORT OR TABLE

(75) Inventors: Sjoerd Nicolaas Lambertus DONDERS, Vught (NL); Noud Jan Gilissen, 's-Gravenzande (NL)

(73) Assignee: ASML NETHERLANDS B.V., Veldhoven (NL)

(21) Appl. No.: 12/886,965

(22) Filed: Sep. 21, 2010

Related U.S. Application Data
(60) Provisional application No. 61/244,772, filed on Sep. 22, 2009.

(51) Int. Cl. G03B 27/58

(52) U.S. Cl. 355/72; 101/463.1

(57) ABSTRACT

A substrate table or a patterning device support includes an aerogel. The aerogel may be very light weight, for example the aerogel may have a density between 0.5 and 500 mg/cm³, preferably between 1 and 100 mg/cm³ and most preferably between 1 and 10 mg/cm³. The aerogel may be made from a silica gel. The aerogel made from silica gel may have a density of 1.9 mg/cm³ and if the air out of the aerogel is evacuated even 1 mg/cm³.

### CROSS REFERENCE TO RELATED APPLICATIONS

This application claims priority and benefit under 35 U.S.C. §119(e) to U.S. Provisional Patent Application No. 61/244,772, entitled “Support Or Table For Lithographic Apparatus, Method Of Manufacturing Such Support Or Table and Lithographic Apparatus Comprising Such Support Or Table”, filed on Sep. 22, 2009. The content of that application is incorporated herein in its entirety by reference.

### FIELD

The present invention relates to a support or table for a lithographic apparatus, a method of manufacturing such a support or table and a lithographic apparatus including such a support and a method for manufacturing a device.

### BACKGROUND

A lithographic apparatus is a machine that applies a desired pattern onto a substrate, usually onto a target portion of the substrate. A lithographic apparatus can be used, for example, in the manufacture of integrated circuits (ICs). In such a case, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Conventional lithographic apparatus include so-called steppers, in which each target portion is irradiated by exposing an entire pattern onto the target portion at once, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In a lithographic apparatus the patterning device supported by a supporting structure and/or the substrate held by a table may be positioned with high speed and high accuracy.

### SUMMARY

It is desirable to provide an improved material for the support structure and/or the substrate table.

According to an embodiment of the invention, there is provided a support or table for a lithographic apparatus, wherein the support or table includes an aerogel

In another embodiment of the invention, there is provided a method of manufacturing a support or a table for a lithographic apparatus including: creating a colloidal suspension of solid particles; linking the colloidal particles with a reaction creating a gel; and removing the liquid from the gel.

According to a further embodiment of the invention, there is provided a lithographic apparatus including: an illumination system configured to condition a radiation beam; a support constructed to support a patterning device, the patterning device being capable of imparting the radiation beam with a pattern in its cross-section to form a patterned radiation beam; a substrate table constructed to hold a substrate; and a projection system configured to project the patterned radiation beam onto a target portion of the substrate, wherein the support and/or table includes an aerogel.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a method of manufacturing a support or a table for the lithographic apparatus of FIG. 1;

FIG. 3 depicts a support or a table for the lithographic apparatus according to an embodiment of the invention; and

FIG. 4 depicts a support or a table for the lithographic apparatus according to an embodiment of the invention.

### DETAILED DESCRIPTION

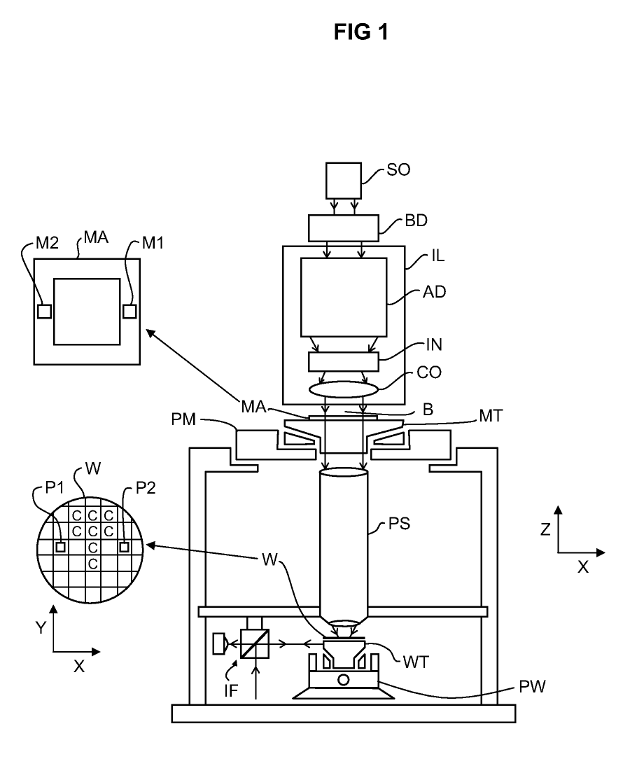

FIG. 1 schematically depicts a lithographic apparatus according to one embodiment of the invention. The apparatus includes an illumination system (illuminator) IL configured to condition a radiation beam B (e.g. UV radiation or any other suitable radiation), a patterning device support or mask support structure (e.g. a mask table) MT constructed to support a patterning device (e.g. a mask) MA and connected to a first positioning device PM configured to accurately position the patterning device in accordance with certain parameters. The apparatus also includes a substrate table (e.g. a wafer table) WT or “substrate support” constructed to hold a substrate (e.g. a resist-coated wafer) W and connected to a second positioning device PW configured to accurately position the substrate in accordance with certain parameters. The apparatus further includes a projection system (e.g. a refractive projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, to direct, shape, or control radiation.

The patterning device support holds the patterning device in a manner that depends on the orientation of the patterning device, the design of the lithographic apparatus, and other conditions, such as for example whether or not the patterning device is held in a vacuum environment. The patterning device support can use mechanical, vacuum, electrostatic or other clamping techniques to hold the patterning device. The patterning device support may be a frame or a table, for example, which may be fixed or movable as required. The patterning device support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section so as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables or “substrate supports” (and/or two or more mask tables or “mask supports”). In such “multiple stage” machines the additional tables or supports may be used in parallel, or preparatory steps may be carried out on one or more tables or supports while one or more other tables or supports are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques can be used to increase the numerical aperture of projection systems. The term “immersion” as used herein does not mean that a structure, such as a substrate, must be submerged in liquid, but rather only means that a liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may include an adjuster AD configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the patterning device support (e.g., mask table) MT, and is patterned by the patterning device. Having traversed the patterning device (e.g. mask) MA, the radiation beam B passes through the projection system PS, which focuses the beam onto a target portion C of the substrate W. With the aid of the second positioning device PW and position sensor IF (e.g. an interferometric device, linear encoder or capacitive sensor), the substrate table WT can be moved accurately, e.g. so as to position different target portions C in the path of the radiation beam B. Similarly, the first positioning device PM and another position sensor (which is not explicitly depicted in FIG. 1) can be used to accurately position the patterning device (e.g. mask) MA with respect to the path of the radiation beam B, e.g. after mechanical retrieval from a mask library, or during a scan. In general, movement of the patterning device support (e.g. mask table) MT may be realized with the aid of a long-stroke module (coarse positioning) and a short-stroke module (fine positioning), which form part of the first positioning device PM. Similarly, movement of the substrate table WT or “substrate support” may be realized using a long-stroke module and a short-stroke module, which form part of the second positioner PW. In the case of a stepper (as opposed to a scanner) the patterning device support (e.g. mask table) MT may be connected to a short-stroke actuator only, or may be fixed. Patterning device (e.g. mask) MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device (e.g. mask) MA, the patterning device alignment marks may be located between the dies.

The depicted apparatus could be used in at least one of the following modes:

1. In step mode, the patterning device support (e.g. mask table) MT or “mask support” and the substrate table WT or “substrate support” are kept essentially stationary, while an entire pattern imparted to the radiation beam is projected onto a target portion C at one time (i.e. a single static exposure). The substrate table WT or “substrate support” is then shifted in the X and/or Y direction so that a different target portion C can be exposed. In step mode, the maximum size of the exposure field limits the size of the target portion C imaged in a single static exposure.

2. In scan mode, the patterning device support (e.g. mask table) MT or “mask support” and the substrate table WT or “substrate support” are scanned synchronously while a pattern imparted to the radiation beam is projected onto a target portion C (i.e. a single dynamic exposure). The velocity and direction of the substrate table WT or “substrate support” relative to the patterning device support (e.g. mask table) MT or “mask support” may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support (e.g. mask table) MT or “mask support” is kept essentially stationary holding a programmable patterning device, and the substrate table WT or “substrate support” is moved or scanned while a pattern imparted to the radiation beam is projected onto a target portion C. In this mode, generally a pulsed radiation source is employed and the programmable patterning device is updated as required after each movement of the substrate table WT or “substrate support” or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

The substrate table WT or the patterning device support MT may include an aerogel. The aerogel may be very light weight, for example the aerogel may have a density between 0.5 and 2200 mg/cm3, preferably between 1 and 500 mg/cm3, more preferably between 1 and 100 mg/cm3, most preferably between 1 and 10 mg/cm3. The aerogel may be made from a silica gel and may have a density of 1.9 mg/cm3 and if the air out of the aerogel is evacuated even 1 mg/cm3. The aerogel may be vacuum compatible which is beneficial for use in a lithographic apparatus because the radiation path within the lithographic projection apparatus may need to be evacuated for example in e-beam or extreme ultraviolet (EUV) lithography. The low weight of aerogel is beneficial because acceleration of the supporting structure or the substrate table in the lithographic apparatus uses less energy. The aerogel may provide very good thermal insulation because it absorbs infrared radiation, has a low thermal conductivity and the lattice structure of the aerogel doesn't allow for convection within the material. Thermal insulation for a support structure or a substrate table may be important because it minimizes heating of the substrate and or the patterning device by the electric actuators in the positioning device PM, PW.

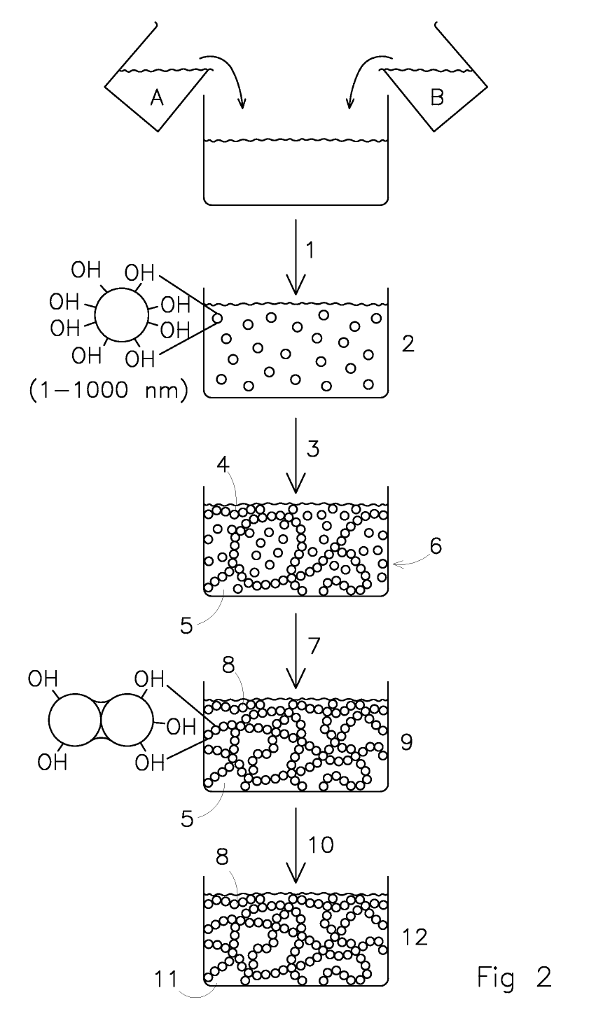

The substrate table WT or the supporting structure MT including aerogel may be made by the sol-gel process as shown in FIG. 2. With this process first a gel is created in a solution and then the liquid is carefully removed. The gel can be created by making a colloidal suspension of solid particles, for example colloidal silica. A liquid alcohol B such as ethanol may be mixed with a silicon alkoxide precursor A, such as tetranethyl orthosilicate (TMOS) or tetraethyl orthosilicate (TEOS). A hydrolysis reaction 1 forms particles of silicon dioxide forming a “sol” solution 2. Subsequently, the silicon dioxide starts a condensation reaction 3 which results in the creation of oxide bridges 4 (either M-O-M, “oxo” or M-OH-M “ol” bridges) wherein M is silicon linking the dispersed colloidal particles in the liquid 5 and creating a gel 6. During aging 7 of the material all colloidal particles get interlinked and form a solid network 8 so that the liquid 5 can not freely flow through the material, the material is called a wet gel 9.

The removal of the liquid 10 from the liquid involves special processing because if the liquid is evaporated in a normal manner the surface tension forces of the liquid-solid interface are strong enough to destroy the fragile gel network 8. To circumvent destruction of the gel network supercritical drying is used. The temperature and pressure of the gel is increased bringing the liquid in a supercritical fluid state. By dropping the pressure the liquid could instantly gasify and be removed from the gel without damage to the gel network. The liquid 5 in the aerogel 12 is in this way replaced by gas 11.

Water in the gel may be replaced before making the liquid supercritical. The water may, for example be flushed away with xenon or acetone. It is also possible to replace the water by ethanol and replace the ethanol subsequently by carbon dioxide. Supercritical drying of acetone can lead to dangerous processing conditions because of the high pressures and temperatures involved. It is saver to do a solvent exchange, for example with liquid ethanol and subsequently replace the liquid ethanol with liquid carbon dioxide above its critical point. Alternatively, one could directly dry the aerogel by controlled evaporation by injecting of a solvent saturated inert gas at temperature around the boiling temperature in the vessel including the gel. The end result of the process is that all liquid is removed from the gel while replacing it with gas without the gel structure collapsing or lose volume. In this example the aerogel is based on silicon. It is also possible to base the aerogel on carbon, titanium, zirconium and/or alumina, preferably in its oxidized form.

The strength of the aerogel may be improved by combining it with other materials like polymers or by heating of the aerogel so as to sinter the material. Sintering may increase the density of the aerogel. The aerogel may be reinforced with fibers (e.g. carbon, boron or Si—Ti—C—O fibers) and sintered so as to obtain a solid quartz composite (e.g. a quartz carbon composite). The solid quartz carbon composite may also be provided with titanium, for example 7% by weight of titanium may be provided in the quartz carbon composite.

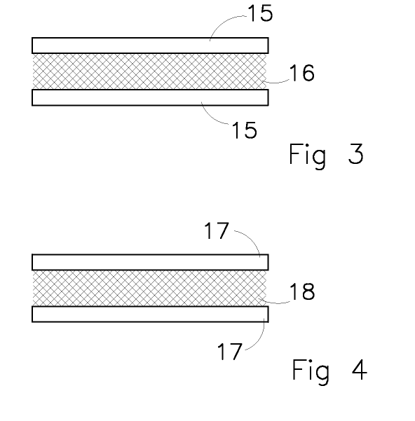

For the application of aerogel in a substrate table WT or patterning device support MT it is beneficial to provide a solid member from quartz and/or carbon forming a layer on the aerogel. FIGS. 3 and 4 show a substrate table or supporting structure including two solid members. In FIG. 3, the solid members are quartz (SIO2) solid members 15 which are bound together by aerogel 16 based on quartz. In FIG. 4 the solid members 17 are carbon quartz composites which are bound together by aerogel 18 based on quartz.

Titanium can be used in the aerogel to adjust the CTE of the aerogel to the CTE of the solid members. Titanium can also be added to an aerogel that has been sintered and has a relatively high density. For example, 7% of weight titanium can be used in the solid sintered material to obtain a material with a high density and which is comparable to, for example ULE® or Zerodure®.

The solid members 15, 16 may be provided with holes and protrusions for mounting items on the substrate table WT or the patterning device support MT. For example, the positioners PW, PM may be connected to the substrate table WT or the patterning device support MT via the solid members 15, 16. Also sensors for controlling the lithographic apparatus, the substrate and the patterning device may be supported via the solid members 15, 16 on the aerogel 16. Breaking the fragile network of the aerogel during use or manufacturing of the substrate table or the supporting structure can be avoided by providing solid members 15, 16 which are providing an interface with the rest of the lithographic apparatus. The solid member may provide a box structure which is filled with aerogel. This assures a light weight and stiff product and the solid member provides enough possibilities for interfacing with the rest of the lithographic apparatus.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

What is claimed is:

1. A support for a lithographic apparatus, the support comprising an aerogel.

2. The support of claim 1, wherein the aerogel has a density between 0.5 and 2200 mg/cm³.

3. The support of claim 1, wherein the aerogel is provided with a material comprising silicon, carbon, titanium, zirconium or alumina.

4. The support of claim 3, wherein the material is oxidized.

5. The support of claim 1, wherein the support is provided with a solid member forming a layer on the aerogel.

6. The support of claim 5, wherein the solid member comprises quartz and/or carbon, boron or Si—Ti—C—O Fibers.

7. The support of claim 5, wherein two solid members are provided and the aerogel is sandwiched between the two members.

8. The support of claim 5, wherein the solid member provides a box structure which is filled with aerogel.

9. The support of claim 1, wherein the aerogel comprises 7% of weight titanium.

10. The support of claim 1, wherein the support is obtained by a method comprising:
creating a colloidal suspension of solid particles;
linking the colloidal particles with a reaction creating a gel; and,
removing the liquid from the gel.

11. The support of claim 10, wherein the method further comprises providing a solid member and linking the solid member with the colloidal particles.

12. The support of claim 11, wherein removing the liquid from the gel comprises supercritical or freeze drying.

13. A method of manufacturing a support for a lithographic apparatus, the method comprising:
creating a colloidal suspension of solid particles;
linking the colloidal particles with a reaction creating a gel; and
removing the liquid from the gel.

14. A lithographic apparatus comprising:
an illumination system configured to condition a radiation beam;
a support constructed to support a patterning device, the patterning device being capable of imparting the radiation beam with a pattern in its cross-section to form a patterned radiation beam;
a substrate support constructed to hold a substrate; and
a projection system configured to project the patterned radiation beam onto a target portion of the substrate,
wherein at least one of the supports comprises an aerogel.

15. The lithographic apparatus of claim 14, wherein the at least one supports is provided with a solid form forming a layer on the aerogel, wherein the patterning device is supported and/or the substrate is held on the solid form.
